(19) United States
(12) Patent Application Publication
(10) Pub. No.: US 2018/0112443 A1
(43) Pub. Date: Apr. 26, 2018

(54) NOISELESS LOCK FOR MOTOR VEHICLE DOOR AND/OR LID WITH ACTUATION LEVER

(71) Applicant: CEBI ITALY S.P.A., Dronero (CN) (IT)

(72) Inventor: Marco SCOCCO, Recanati (MC) (IT)

(21) Appl. No.: 15/784,531

(22) Filed: Oct. 16, 2017

(30) Foreign Application Priority Data
Oct. 26, 2016 (IT) 102016000108219

(51) Int. Cl. E05B 77/36; E05B 85/02; E05B 81/16; E05B 81/30; E05B 81/34

(52) U.S. Cl. CPC E05B 77/36; E05B 85/02; E05B 81/34; E05B 81/30; E05B 81/16

(57) ABSTRACT

A lock for a motor vehicle door and/or lid includes: a closing hook, a pawl acting on the closing hook to lock the closing hook in closing position, an actuation lever acting on the pawl to release the pawl from a closing position, an electrical motor that actuates the actuation lever by means of a transmission means. The actuation lever has a body connected to a wall of the box in such manner to rotate and translate with respect to the wall of the box, and the actuation lever comprises a follower that protrudes from the body and is engaged in a cam obtained in the wall of the box, wherein the cam defines a closed loop circuit to control the movement of the actuation lever.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present patent application for industrial invention relates to a lock for motor vehicle door and/or lid, in particular for the trunk lid.

### 2. Description of Related Art Including Information Disclosed Under 37 CFR 1.97 and 37 CFR 1.98

Several types of locks for vehicle doors and/or lids are known on the market. Said locks comprise a closing hook that is engaged in a “U”-shaped pin fixed to the body of the motor vehicle. A stop lever, commonly known as “pawl”, is engaged with the closing hook to lock the closing hook and keep it in closing position. In order to open the lock, the pawl is actuated by an electrical motor that actuates gears.

A type of lock is known, wherein the electrical motor rotates an endless screw that engages in a female screw of a slide that actuates on the pawl. The operation of such a lock is not noiseless because of the noise of both the forward travel and the backward travel of the slide generated by the engagement between screw and female screw.

Another type of lock is known, wherein the electrical motor rotates an endless screw that engages in a housing obtained directly in the pawl. Such a solution eliminates the presence of the slide, but it is still characterized by the noise generated by the engagement between the endless screw and the housing of the pawl.

The purpose of the present invention is to eliminate the drawbacks of the prior art by providing a lock for motor vehicle door and/or lid that is noiseless and reliable.

Another purpose of the present invention is to provide such a lock for motor vehicle door and/or lid that is not bulky and easy to produce and assemble.

### BRIEF SUMMARY OF THE INVENTION

These purposes are achieved according to the invention with the characteristics of the independent claim 1.

Advantageous embodiments of the invention appear from the dependent claims.

The lock for motor vehicle door and/or lid according to the invention comprises:
a closing hook hinged to a box of the lock, around a pivoting axis, said closing hook comprising a slot suitable for fastening a pin that is fixed to the motor vehicle body,
a pawl hinged to the box of the lock around a pivoting axis and acting on said closing hook to lock the closing hook in closing position,
an activation lever that acts on the pawl to release the pawl from a closing position, and
an electrical motor that actuates the actuation lever by means of transmission means.

The actuation lever has a body that is connected to a wall of the box, in such manner to rotate and translate with respect to the wall of the box. The actuation lever comprises a follower that protrudes from the body and is engaged in a cam obtained in said wall of the box, wherein the cam defines a closed loop circuit in order to control the movement of the actuation lever.

The advantages of the lock according to the invention are evident: the provision of the actuation lever that is automatically reset by the cam avoids the movement and the noise of the gears of the transmission means for resetting the actuation lever that must actuate the pawl.

### BRIEF DESCRIPTION OF THE SEVERAL VIEWS OF THE DRAWINGS

Additional features of the invention will appear manifest from the following description, which refers to a merely illustrative, not limiting embodiment, as shown in the attached figures, wherein:

FIG. 1 is a perspective view of the lock according to the invention in an initial closing position.

FIG. 2 is a perspective view of some parts of the lock of FIG. 1, seen from a different angle.

FIG. 3 is a perspective view of a wall of the box of the lock.

FIG. 3A is an enlarged view of a cam of the wall of FIG. 3.

FIGS. 4 and 4A are perspective views of parts of 5 the lock seen from different angles at the beginning of an opening step.

FIGS. 5 and 5A are perspective views of the parts of the lock seen from different angles at the end of the opening step.

FIGS. 6 and 6A are perspective views of parts of the lock seen from different angles at the beginning of a resetting step.

FIGS. 7 and 7A are perspective views of the parts of the lock seen from different angles at the end of the resetting step.

FIGS. 8A-8E are perspective views like FIG. 3A, except that they show the follower in the cam in different positions.

### DETAILED DESCRIPTION OF THE INVENTION

With reference to the Figures, the lock according to the invention is disclosed, which is generally indicated with reference numeral 100.

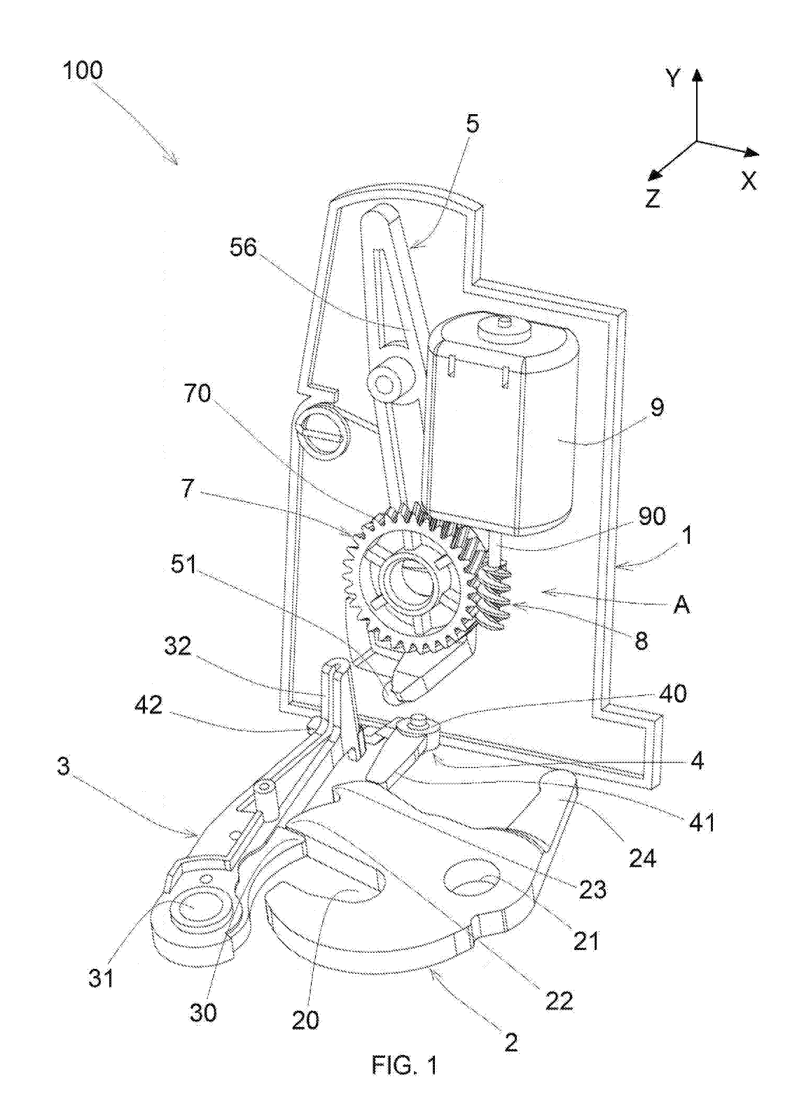

With reference to FIG. 1, reference is made to a set of three Cartesian axes (X, Y, Z).

The lock (100) comprises a closing hook (2) suitable for fastening a pin (not shown), which generally has a “U”-shape. The pin is fixed to the vehicle body. Instead, the lock (100) is disposed in a box fixed to the lid of the vehicle. Only one wall (1) of the box is shown.

The body of the closing hook (2) is shaped as a plate provided with a “U”-shaped slot (20) that is suitable for fastening the pin.

A pivoting hole (21) is obtained in the body of the closing hook to pivot the closing hook in the box that contains the lock, around a pivoting axis parallel to the axis Y.

The closing hook (2) comprises a first tooth (22) that protrudes in the proximity of the slot (20) and a second tooth (23) that protrudes in remote position from the slot (20). An arm (24) protrudes from the body of the closing hook in orthogonal direction to the slot (20).

The closing hook (2) is stressed towards the closing position by means of a spring (not shown).

A pawl (3) is shaped as a lever with a pivoting hole (31) for pivoting the pawl in the box, around a pivoting axis parallel to the axis Y.

The pawl (3) has a tooth (30) directed towards the closing hook and suitable for being stopped against the first tooth (22) of the closing hook to keep the closing hook in open position.

The pawl (2) is stressed by a spring (not shown in the figures) towards the closing position wherein the tooth (30) of the pawl is stopped against the first tooth (22) of the closing hook.

The pawl (3) is shaped like an “L”-lever and comprises a projection (32) that protrudes in parallel direction to the axis (Y) from one end of the pawl in distal position with respect to the pivoting hole (31) of the pawl.

A memory lever (4) comprises a central body (40) pivoted to the box with an axis parallel to the axis (Y). A first arm (41) and a second arm (42) protrude in orthogonal position from the central body (40) of the memory lever. When the lock is in closing position, the first arm (41) of the memory lever is stopped against the second tooth (23) of the closing hook and the second arm (42) of the memory lever is stopped against the projection (32) of the pawl.

A spring (not shown in the figures) stresses the memory lever (4) in closing position.

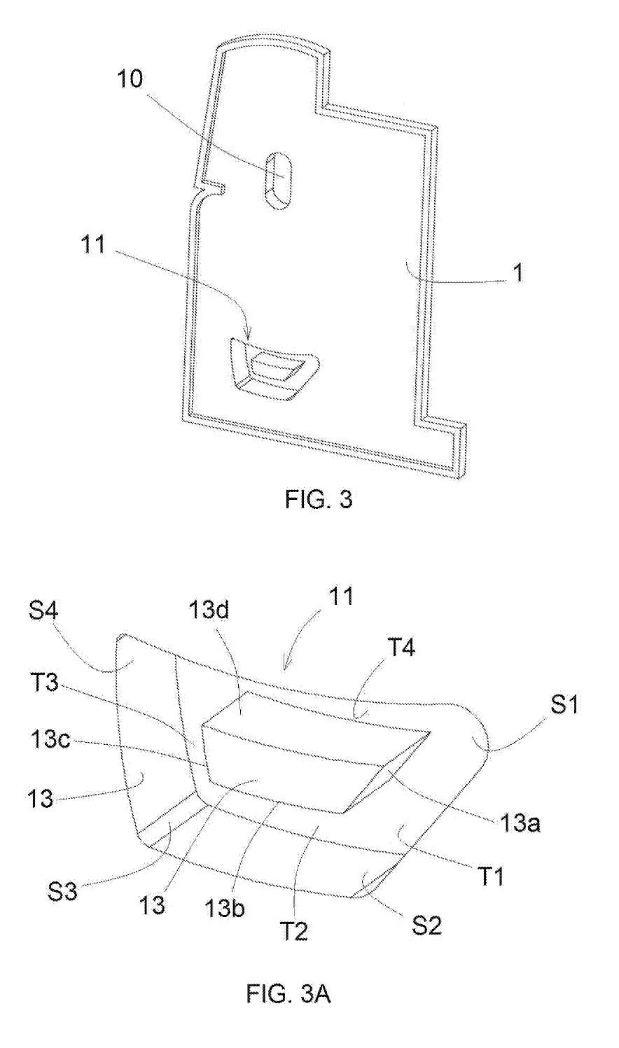

An actuation lever (5) comprises a body (56) and a pin (50) disposed in an intermediate position of the body and hinged in a slot (10) (see FIG. 3) obtained in the wall (1) of the box, with a pivoting axis that is parallel to the axis Z. The slot (10) has an elliptical shape with major axis parallel to the axis Y. In view of the above, the pin (50) of the actuation lever (5) can rotate in the slot (10) around an axis parallel to the axis Z and can translate in the slot (10) along the major axis of the slot that is parallel to the axis Y. Obviously, likewise, a slot can be provided in the body (56) of the actuation lever and a pin can be provided in the wall (1) of the box. The important fact is that the actuation lever (5) can rotate and translate with respect to the wall (1) of the box.

The actuation lever (5) is shaped as an “L”-lever and comprises a first arm (51) that protrudes from the body (56) in parallel direction to the axis (Z). The first arm (51) of the actuation lever is suitable for being stopped against the projection (32) of the pawl.

The actuation lever (5) has a follower (52) in the form of a pin that protrudes from the body (56) and is engaged in a cam (11) (see FIG. 3) obtained in the wall (1) of the box.

With reference to FIG. 3A, the cam (11) comprises a perimeter frame (12) that defines a housing wherein a central island (13) with substantially trapezoidal shape is disposed. The central island (13) has a first side (13a), a second side (13b), a third side (13c) and a fourth side (13d).

Four housings (S1, S2, S3, S4) are defined in the perimeter frame (12), being disposed in the four corners of the central island (13).

In view of the above four sliding tracks are defined in the cam (11): a first track (T1) going from the first housing (S1) to the second housing (S2), a second track (T2) going from the second housing (S2) to the third housing (S3), a third track (T3) going from the third housing (S3) to the fourth housing (S4) and a fourth track (T4) going from the fourth housing (S4) to the first housing (S1). The four tracks (T1, T2, T3, T4) form a closed loop circuit.

Although the Figures show an embodiment wherein the follower (52) is obtained in the actuation lever (5) and the cam (11) is obtained in the wall (1) of the box, the follower can be likewise obtained in the wall (1) of the box and the cam can be obtained in the body (56) of the actuation lever (5).

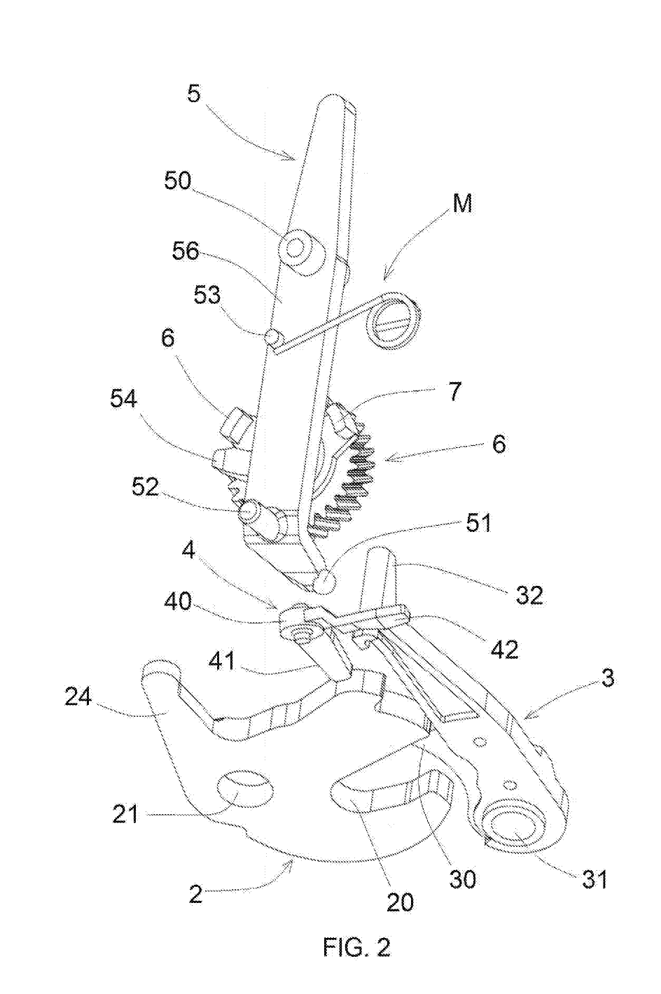

With reference to FIG. 2, a spring (M) stresses the actuation lever (5) upwards, in parallel direction to the arrow (Y), creating a moment that tends to return the actuation lever (5) to the starting position. To that purpose, the spring (M) is a torsional spring provided with an end that pushes a pin (53) disposed in the body (56) of the actuation lever (5).

The actuation lever (5) comprises a second arm (54) that protrudes from the body (56) of the actuation lever in a direction that is parallel to the axis X and orthogonal to the first arm (51).

The actuation lever (5) is moved by an electrical motor (9) by means of a transmission (A). The transmission (A) comprises an endless screw (8) actuated by the electrical motor (9) that drives into rotation a toothed wheel (7) that moves the actuation lever (5).

The toothed wheel (7) is revolvingly mounted in the box in such a way to rotate around an axis that is parallel to the axis Z. The toothed wheel (7) has teeth (70), preferably of helical type. The endless screw (8) engages in the teeth (70) of the toothed wheel in order to rotate the toothed wheel (7). The endless screw (8) is supported by a drive shaft (90) of the electrical motor (9). The electrical motor (9) rotates only in one direction.

The toothed wheel (7) comprises at least one protruding wing (6) suitable for pushing the actuation lever. Preferably, three protruding wings (6) are provided in peripheral position in the toothed wheel (7), protruding from the toothed wheel in parallel direction to the axis Z in order to be stopped against the second arm (54) of the actuation lever. Advantageously, the toothed wheel comprises three protruding wings (6) that are angularly spaced by an angle of approximately 120°.

The electrical motor (9) is configured in such a way to actuate the toothed wheel (30) in steps. Every time the electrical motor (9) is actuated, the toothed wheel (7) rotates by an angle that is a submultiple of the round angle, for example such an angle is one third of a round angle, i.e. 120°. Consequently, one of the protruding wings (6) of the toothed wheel is stopped against the second arm (54) of the actuation lever, permitting a movement of the actuation lever, in accordance with the pin (50) of the actuation lever engaged in the slot (10) of the wall and with the follower (52) of the actuation lever that circulates in the cam (11) of the wall of the box.

The operation of the lock (100) is described below.

With reference to FIGS. 1 and 2, the lock (100) is in closed position. The closing hook (2) locks the pin (not shown) of the chassis of the vehicle; the pawl (3) locks the closing hook (2); the arms (41, 42) of the memory lever (4) are respectively stopped against the second tooth (23) of the closing hook and against the projection (32) of the pawl; and the first arm (51) of the actuation lever (5) is in distal position with respect to the projection (32) of the pawl (3).

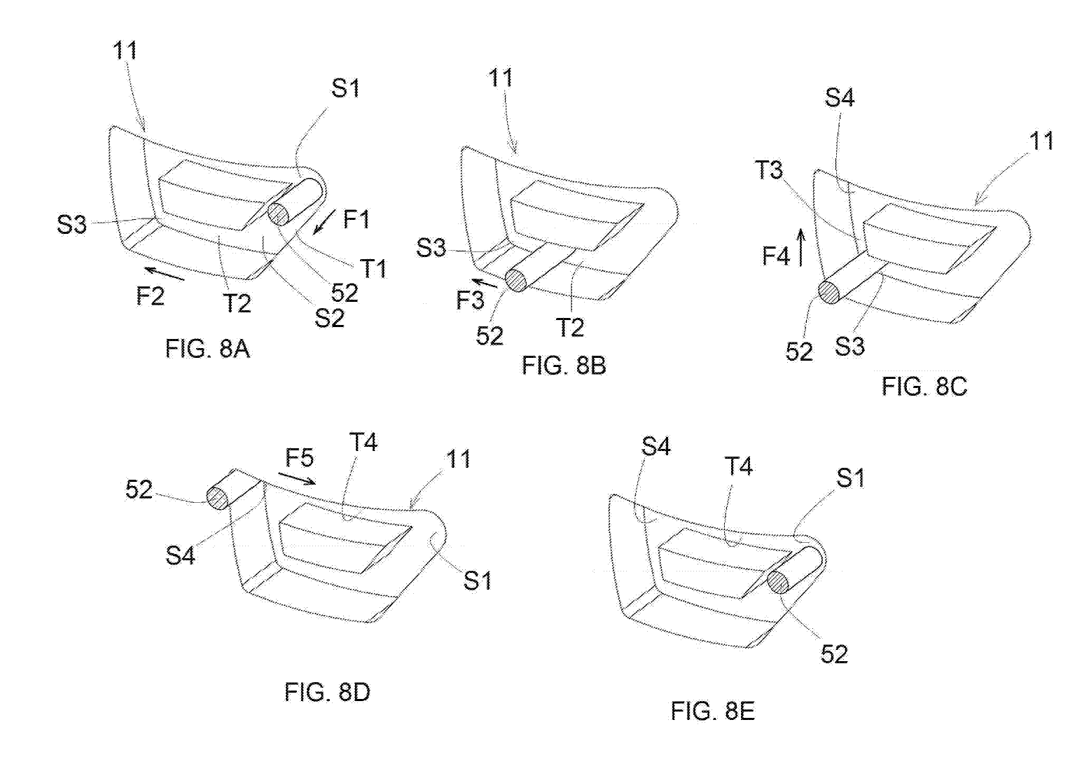

With reference to FIG. 8A, when the lock is in closing position, the follower (52) of the actuation lever is in the first housing (S1) of the cam (11) of the wall of the box.

When the electrical motor (9) is actuated to open the lock, the endless screw (8) engages with the teeth (70) of the toothed wheel, rotating the toothed wheel (7) by 120°. Consequently, one of the protruding wings (6) of the toothed wheel is stopped against the second arm (54) of the actuation lever, pushing the second arm (54) of the actuation lever and moving the actuation lever (5).

Given that the pin (50) of the actuation lever can rotate and translate in the island (10), the follower (52) of the actuation lever moves in the direction of the arrow F1 along the first track (T1) of the cam, passes beyond the second housing (S2) and moves in the direction of the arrow F2 along the second track (T2) of the cam. When the follower (52) moves along the first track (T1) of the cam, the actuation lever (5) is lowered and the spring (M) is loaded.

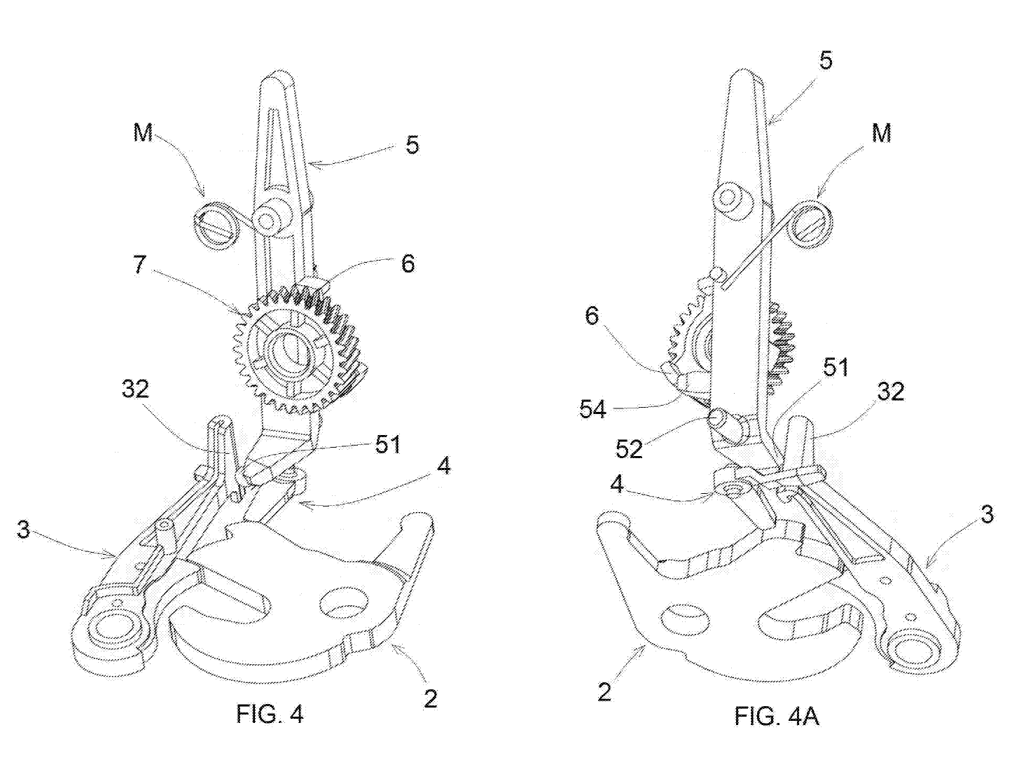

With reference to FIGS. 4 and 4A, the first arm (51) of the actuation lever (5) is stopped against the projection (32) of the pawl (3). With reference to FIG. 8B, in such a situation, the follower (52) of the actuation lever is disposed in the middle of the second track (T2). In view of the continuation of the thrust of the actuation lever (5) by the protruding wing (6) of the toothed wheel that pushes the second arm (54) of the actuation lever, the first arm (51) of the actuation lever pushes the projection (32) of the pawl. The follower (52) moves along the second track (T2) in the direction of the arrow F3.

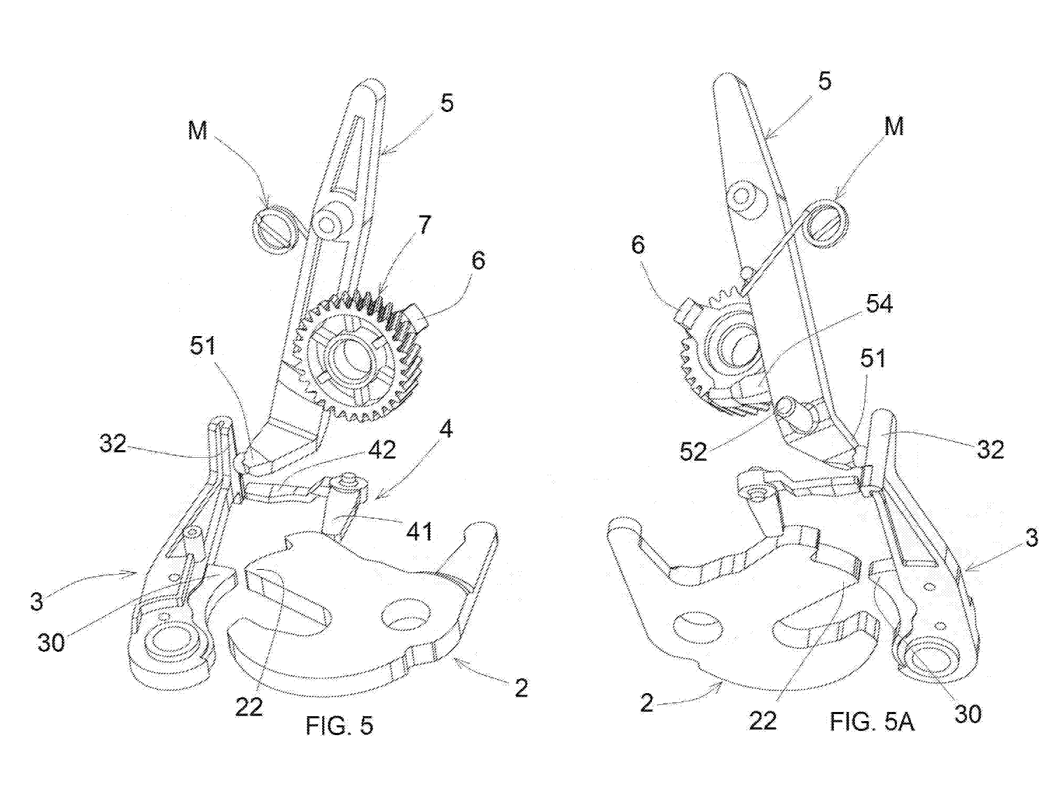

Consequently, as shown in FIGS. 5 and 5A, the pawl (3) rotates around its pivoting axis and the tooth (30) of the pawl disengages the first tooth (22) of the closing hook. In such a situation, the closing hook (2) is free and can be opened, by opening the lid, in such a way that the pin is disengaged from the housing of the closing hook. It must be noted that the second arm (42) of the memory lever is disengaged from the projection (32) of the pawl.

Now the opening step of the lock is concluded. During the opening step of the lock, the toothed wheel (7) has rotated by only 120°.

With reference to FIG. 8C, at the end of the opening step, the follower (52) of the actuation lever is in the third housing (S3) of the cam. Given the fact that the spring (M) is loaded, the spring (M) pushes the actuation lever (5) upwards; therefore, the follower (52) of the actuation lever moves in the direction of the arrow F4 along the third track (T3) of the cam.

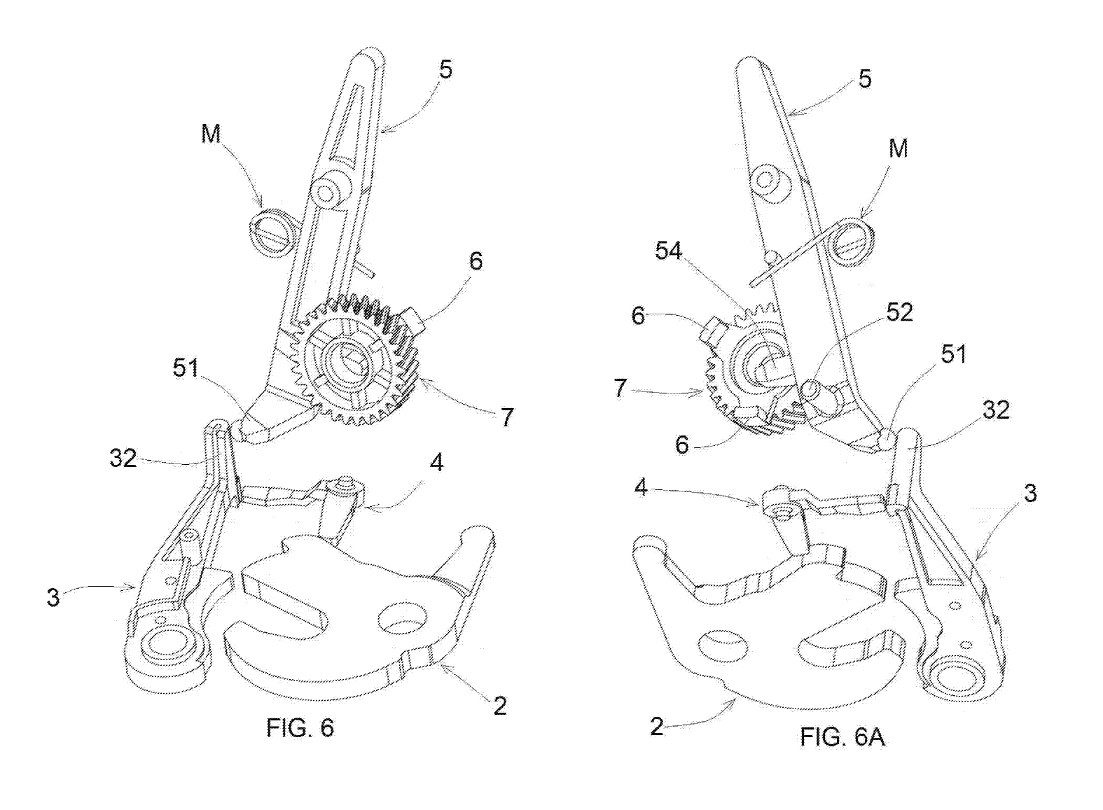

As a result, the actuation lever (5) is lifted, starting the resetting step of the actuation lever, as shown in FIGS. 6 and 6A. With reference to FIG. 8D, the follower (52) reaches the fourth housing (S4) of the cam.

Because of the thrust of the spring (M) and because of the fact that the pin (50) of the actuation lever can rotate and translate in the slot (10) of the wall of the box, the follower (52) of the actuation lever moves in the direction of the arrow F5 along the fourth track (T4) of the cam, returning to the first housing (S1) of the cam, as shown in FIG. 8E.

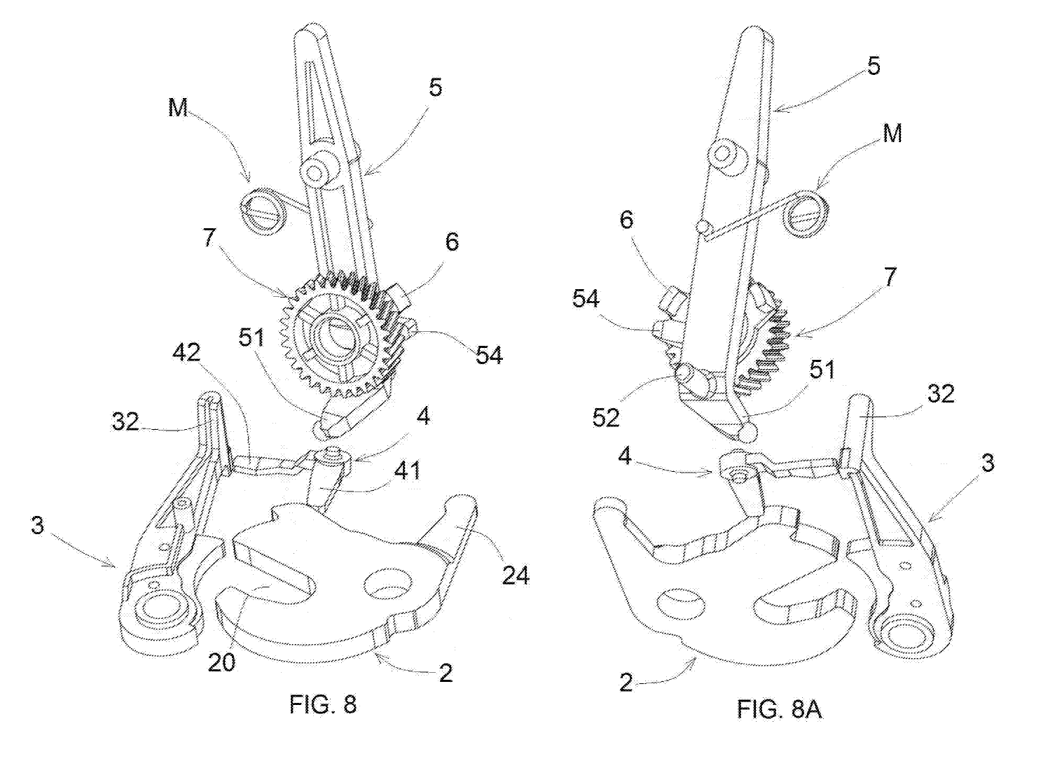

With reference to FIGS. 7 and 7A, now the resetting step has concluded and the actuation lever (5) is reset in the starting position.

It must be noted that the toothed wheel (7) does not rotate during the resetting step of the actuation lever (5); therefore there is no engagement between the endless screw (8) and the teeth of the toothed wheel (7), thus eliminating any kind of gear noise. The only gear noise is generated during the opening step, when the toothed wheel (7) engages with the endless screw (8) in order to be rotated by 120°.

Going back to FIGS. 7 and 7A, when the user opens the lid, the pin of the chassis that is disposed in the housing (20) of the closing hook pushes and rotates the closing hook (2). As a result, the arm (24) of the closing hook is stopped against the first arm (41) of the memory lever (4), resetting the memory lever.

Numerous equivalent variations and modifications can be made to the present embodiment of the invention, which are within the reach of an expert of the field, and fall in any case within the scope of the invention.

I claim:

1. Lock for motor vehicle door and/or lid comprising:
a closing hook hinged to a box of the lock, around a pivoting axis, said closing hook comprising a slot suitable for fastening a pin that is fixed to the motor vehicle body;
a pawl hinged to the box of the lock around a pivoting axis and acting on said closing hook to lock the closing hook in closing position;
an actuation lever that acts on the pawl to release the pawl from a closing position;
an electrical motor that actuates the actuation lever by means of transmission means; wherein
the actuation lever has a body that is connected to a wall of the box, in such manner to rotate and translate with respect to the wall of the box, and
the actuation lever is engaged with the wall of the box, in follower and cam coupling mode, wherein the cam defines a closed loop circuit to control the movement of the actuation lever.

2. The lock of claim 1, wherein said pawl is shaped like an “L”-lever comprising a projection and said actuation lever has an “L”-shape comprising a body hinged to said wall and a first arm that protrudes from the body in order to stop against the projection of the pawl, wherein the pivoting axis of the pawl is orthogonal to a pivoting axis of the actuation lever.

3. The lock of claim 1, wherein said transmission means comprise an endless screw actuated by the electrical motor and engaging in teeth of a toothed wheel suitable for moving said actuation lever.

4. The lock of claim 3, wherein said toothed wheel comprises at least one protruding wing that protrudes from the toothed wheel in order to stop against a second arm of the actuation lever that protrudes from the body of the actuation lever.

5. The lock of claim 4, wherein said toothed wheel comprises three protruding wings equally spaced by an angle of 120°.

6. The lock of claim 1, wherein said cam comprises a perimeter frame that defines a housing wherein a central island with substantially trapezoidal shape is disposed, having four sides that define four tracks.

7. The lock of claim 1, comprising a spring that stresses said actuation lever.

8. The lock of claim 1, wherein the electrical motor is configured in such manner to rotate the toothed wheel by an angle that is a submultiple of a round angle every time the electrical motor is actuated.

9. The lock of claim 8, wherein the electrical motor is configured in such manner to rotate the toothed wheel by 120° every time the electrical motor is actuated.

10. The lock of claim 1, wherein said actuation lever has a pin that protrudes from the body of the actuation lever and is engaged in a slot obtained in such wall of the box, so that said pin of the actuation lever can rotate and translate in said slot of the wall of the box.

11. The lock of claim 1, wherein said follower is a pin that protrudes from the body of the actuation lever and said cam is obtained in said wall of the box.
